(19) United States
(12) Patent Application Publication
(10) Pub. No.: US 2026/0204988 A1
(43) Pub. Date: Jul. 16, 2026

(54) AXIAL FLUX MOTOR, GEAR MOTOR AND CONVEYOR

(71) Applicant: AVANCON SA, Riazzino (CH)

(72) Inventor: Daniele GAMBETTA, Giubiasco (CH)

(21) Appl. No.: 19/138,390

(22) PCT Filed: Dec. 14, 2022
(86) PCT No.: PCT/EP2022/085971

§ 371 Date: Jun. 12, 2025

(51) Int. Cl. H02K 11/215; H02K 5/173; H02K 5/22; H02K 7/00; H02K 7/116

(52) U.S. Cl. CPC H02K 11/215; H02K 5/1735; H02K 5/225; H02K 7/003; H02K 7/116; H02K 2211/03

(57) ABSTRACT

An axial flux motor comprising a housing (1) with a base plate (10), a PCB (2), a stator (3) and a rotor (4), wherein the PCB (2) is arranged between the base plate (10) and the stator (3), and wherein the rotor (4) is arranged in a reception (12) of the housing (1) that has the shape of a sleeve and extends coaxial to the stator (3) from the base plate (10), wherein a slot (120) is formed in the reception (12), extending from the base plate (10) to a free end of the reception (12), wherein the PCB (2) comprises an island (21), and wherein a reference magnet (43) is arranged on a first free end of the shaft (40) facing the PCB (2) and wherein a sensor (23) is arranged on the island (21) of the PCB (2) facing the shaft (40) and which together form a position sensor for the rotor (4).

### TECHNICAL FIELD OF THE INVENTION

The current invention relates to electric motors, in particular to axial flux motors.

### DESCRIPTION OF THE RELATED ART

Known embodiments of such axial flux motors comprise a housing in which a stator with coils is arranged concentrically around a shaft of a rotor that is rotatably mounted in the housing, wherein a magnetic disc is attached to the shaft, adjacent to the stator and covering its coils. A printed circuit board (PCB) is arranged adjacent to the stator, opposite the magnetic disc. The PCB has the shape of an annular disc through which the shaft protrudes. With such a design, the integration of a position detection of the shaft is complex to manufacture or complex to assemble. For example, it requires a complex production of the housing or a complex wiring.

### SUMMARY OF THE INVENTION

It is a task of current invention to provide an axial flux motor with a position detection of the shaft, avoiding the above-mentioned disadvantages.

This task is solved by an axial flux motor with the features of claim 1. Further embodiments of the axial flux motor, a gear motor with such an axial flux motor as well as a conveyor with such an axial flux motor are defined by the features of further claims.

An axial flux motor according to the invention comprises a housing with a base plate, a printed circuit board (PCB), a stator with coils and cores, and a rotor with a shaft, a disc and drive magnets. The PCB is arranged between the base plate and the stator, and the rotor is arranged in a reception of the housing that has the shape of a sleeve and extends coaxial to the stator from the base plate in between the coils. A slot is formed in the reception, extending from the base plate to a free end of the reception. The PCB comprises a recess through which the reception protrudes, an island which is arranged in a central part of the reception, and a connecting bridge that connects the island with the rest of the PCB and that is arranged in the slot of the reception. A reference magnet is arranged on a first free end of the shaft facing the PCB and a sensor is arranged on the island of the PCB facing the shaft and which together form a position sensor for the shaft.

This design has the advantage that sensor is integrated into the PCB and no additional wiring is required, allowing an easy assembling of the axial flux motor.

The cores of the stator can be sintered cores. The reception may be formed integrally in a single piece with the base plate of the housing. Alternatively, the reception can be a separate piece that is fixed to the base plate. The space between the side walls and the reception may be filled with raisin, enclosing the PCB in this region completely and enclosing the stator at least laterally. The raisin may contain epoxy or the like. The top of the cores and coils is free from raisin.

In one embodiment, the shaft is arranged in the reception with at least one bearing. The bearing closest to the base plate rests on a shoulder of the reception. Depending on the size of the motor, two or more bearings can be arranged in the reception. The bearings can be any type of rolling-element bearing or plain bearing.

In one embodiment, the shaft comprises a collar, which rests on the bearing furthest away from the base plate with its side facing the base plate and on which collar rests the disc on the side facing away from the base plate.

In one embodiment, a first bolt is provided on a side of a second free end of the shaft opposite to the first free end, which first bolt is arranged in a complementary recess of the disc forming a form-and/or force-fit connection.

In one embodiment, the axial flux motor comprises a shaft extension which is arranged in a thereto complementary socket, formed in the first bolt.

In one embodiment, a second bolt is provided at the second free end of the shaft.

In one embodiment, the reference magnet is arranged in a recess in the front face of the shaft.

In one embodiment, a third bolt is provided on a side of the disc facing away from the base plate.

In one embodiment, cooling ribs are provided on a side of the base plate opposite the PCB.

In one embodiment, lateral side walls extend away from the base plate in the direction of the disc, respectively in the direction of the PCB. The side walls may extend beyond the coils and cores of the stator. They may also extend beyond the disc and/or beyond the shaft. The side walls may be formed integrally in a single piece with the base plate.

In one embodiment, a cut-out is formed in one of the side walls of the housing and wherein the PCB comprises a connector which is accessible from the outside through the cut-out.

For example, the housing can be made from aluminum, the stator core from sintered metal, the coils from copper, the rotor disc from sintered steel and the rotor shaft from stainless steel.

The features of the above-mentioned embodiments of the axial flux motor can be used in any combination, unless they contradict each other.

A gear motor according to the invention comprises the axial flux motor according to any of the preceding embodiments and a gearbox with a drive gear and at least one driven gear, wherein the drive gear is fixed to the shaft.

A conveyor according to the invention comprises conveying means that are operatively connected to the axial flux motor according to any of the preceding embodiments or to the above-mentioned gear motor.

In one embodiment, the conveyor comprises a power and/or control unit which supplies the axial flux motor or the gear motor according with power and/or control signals.

Obviously, the power and/or control unit may receive signals from the axial flux motor, be it control signals, measurement signals or others.

### BRIEF DESCRIPTION OF THE DRAWINGS

Embodiments of the current invention are described in more detail in the following with reference to the figures.

These are for illustrative purposes only and are not to be construed as limiting. It shows

FIG. 1 a perspective view of a first embodiment of an axial flux motor according to the invention;

FIG. 2 a section view through the rotation axis of the axial flux motor of FIG. 1;

FIG. 3 a perspective view of the housing of the axial flux motor of FIG. 1;

FIG. 4 a perspective view of the PCB of the axial flux motor of FIG. 1;

FIG. 5 a section view through the rotation axis of a second embodiment of an axial flux motor according to the invention;

FIG. 6 a perspective view of a gear motor according to the invention;

FIG. 7 a section view through the rotation axis of the gear motor of FIG. 6; and

FIG. 8 a perspective view of a conveyor according to the invention.

### DETAILED DESCRIPTION OF THE INVENTION

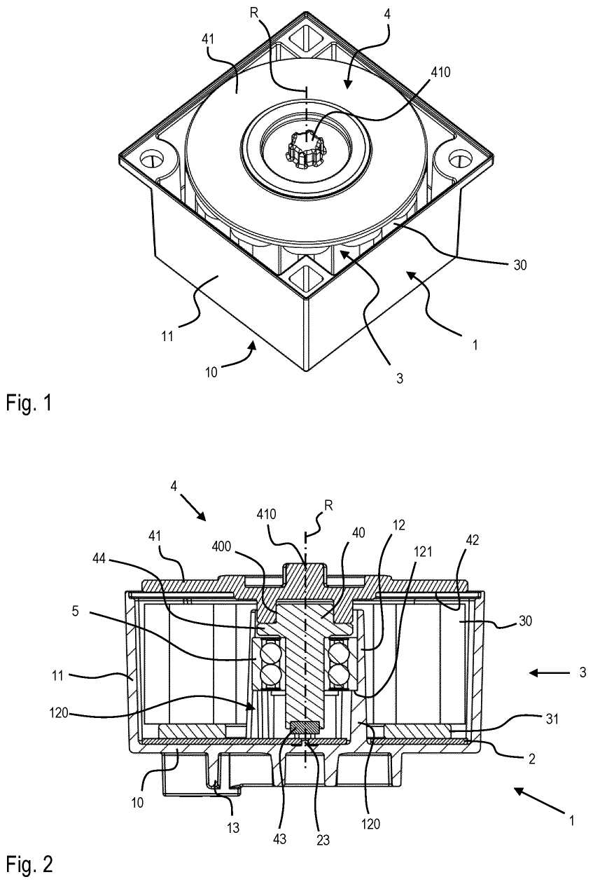

FIG. 1 shows a perspective view of a first embodiment of an axial flux motor according to the invention. The motor comprises a housing 1 with a base plate 10 and lateral side walls 11, that extend from the lateral edges of the base plate 10. The base plate 10 has an essentially square layout. In the corners of the housing 1, stiffing elements or fixation elements are arranged. In the depicted housing, these elements are formed integrally in a single piece with the side walls and the base plate. The stator 3 with its coils 30 is arranged completely within the housing. The coils are arranged evenly distributed around the rotation axis R. The rotor 4 with its disc 41 is arranged above the stator 3, wherein the disc 41 completely covers all coils 30. The rotor 4 is arranged concentric to and rotatable around the rotation axis R. In the center of the disc 41, a third bolt 410 is arranged that extends upwards from the disc and thereby provides a good connection to an element to be driven.

FIG. 2 shows a section view through the rotation axis R of the axial flux motor of FIG. 1. The side walls 11 are formed integrally in a single piece with the base plate 10. The reception 12 extends from the base plate 10 upwards in between the side walls 11. The reception 12 is formed integrally in a single piece with the base plate. On one side, the reception 12 comprises a slot 120 that extends from the base plate over the entire height of the reception. Through said slot 120, the PCB extends from a region outside of the reception to the inside thereof. The reception comprises a shoulder 121 on which a bearing 5 rests. The shown bearing is a double row ball bearing. A shaft 40 is rotatably mounted in the housing 1 by means of the bearing 5. The shaft 40 comprises a collar 44 which rests with its one side on the bearing. The disc 41 rests on the other side of the collar. On the lower free end of the shaft, a reference magnet 43 is arranged. In the depicted case, the reference magnet is fixed in a recess in the end face of the shaft 40. The shaft exceeds the bearing as such that there is a small gap between the reference magnet and the PCB 2 in which a sensor 23 is integrated. The reference magnet 43 forms a position sensor together with the sensor 23, or an orientation detector for the shaft 40, respectively for the rotor 4. On the upper free end of the shaft, a first bolt 400 is arranged which is arranged in a thereto complementary recess of the disc 41. The disc has a sleeve that comprises said recess and which sleeve extends in between the coils 30 of the stator 3. On the other side of the sleeve, the third bolt 410 is arranged, wherein the third bolt is coaxial with the sleeve and the rotation axis R. The cores 31 of the stator 3 are arranged on the PCB 2 and extend upwards towards the top opening of the housing 1. The cores and the coils of the stator are completely covered by the disc 41. The disc extends in the direction of the rotation axis R to the outside of the housing, i.e., over the free upper edges of the side walls 1. On the side of the disc facing the PCB 2, drive magnets 42 are arranged which are evenly distributed around the circumference of the disc. At the base plate 10, on the outside of the housing 1, cooling ribs 13 are arranged, providing a good cooling for the PCB 2 that is arranged on the base plate 10 on the inside of the housing 1 and the whole stator. The short distance between the PCB and the cooling ribs 13 and the big contact area of the PCB with the base plate increases the cooling capacity.

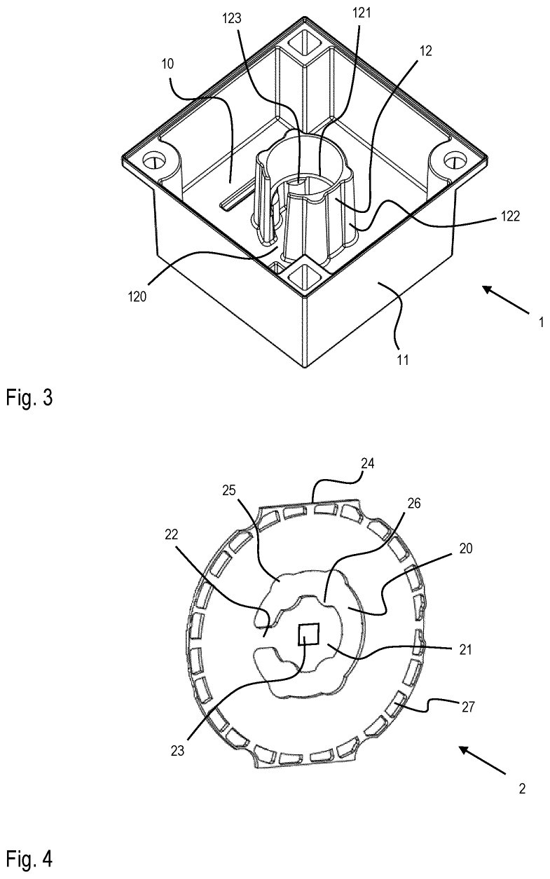

FIG. 3 shows a perspective view of the housing 1 of the axial flux motor of FIG. 1 and FIG. 2. The reception 12 comprises outer reinforcing ribs 122 on the outside of the reception that extend from the base plate 10 over the entire height of the reception and that are distributed around its circumference and comprises inner reinforcing ribs 123 on the inside of the reception that extend from the base plate 10 to almost the shoulder 121 and that are concentrically oriented with the outer reinforcing ribs 122.

FIG. 4 shows a perspective view of the PCB 2 of the axial flux motor of FIG. 1 and FIG. 2. It is disc-shaped and its outer edge is essentially round. A C-shaped recess 20 is formed in the PCB, concentrically to the outer edge, resulting in an island 21 that is located in the center of the PCB and a connecting bridge 22, that connects the outer ring of the PCB to the island. In the center of the island 21, the sensor 23 is arranged. Outside clearances 25 are arranged on the outer side of the recess 20 and inner clearances 26 on its inner side, wherein they are complementary to the outer reinforcing ribs respectively the inner reinforcing ribs of the reception of the housing. The outer edge of the PCB comprises straight sections 24 on two opposing sides that in the assembled state are parallel to the respective side walls of the housing. Soldering pads 27 are arranged in the edge region of the PCB, evenly distributed around its circumference. In the assembled state, the coils are soldered to these pads 27.

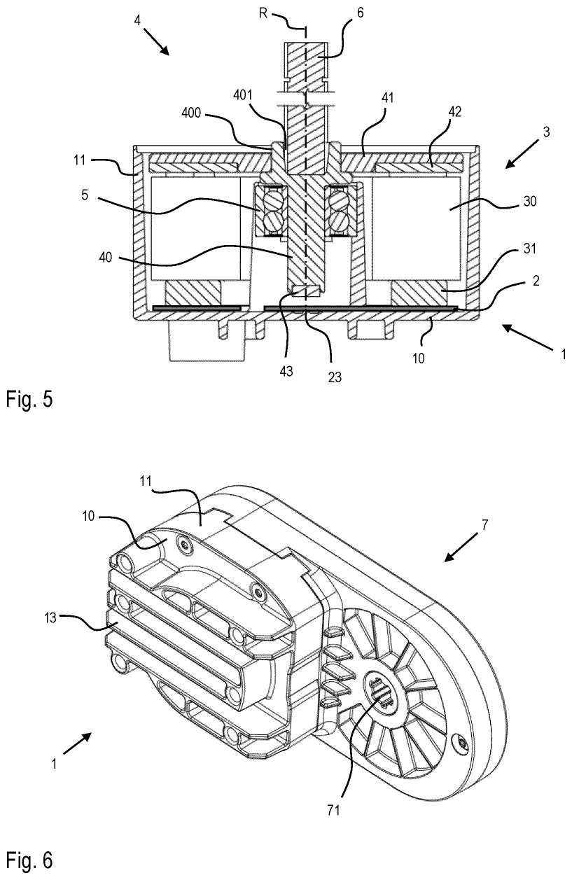

FIG. 5 a section view through the rotation axis of a second embodiment of an axial flux motor according to the invention. In this embodiment, the coils 30 and cores 31 of the rotor 3 extend less upwards towards the upper edges of the side walls 11 and the disc 41 of the rotor does not extend beyond the upper edges of the side walls. The first bolt 400 of the shaft extends through a thereto complementary through hole of the disc 41. A socket 401 is formed in the center of the first bolt for receiving a shaft extension 6. The shaft extension can be connected to an element to be driven.

FIG. 6 shows a perspective view of a gear motor according to the invention. In this embodiment, the base plate 10 is essentially square shaped and has rounded corner regions. A gearbox 7 is arranged on the free edges of the side walls 11 of the housing 1 of the axial flux motor.

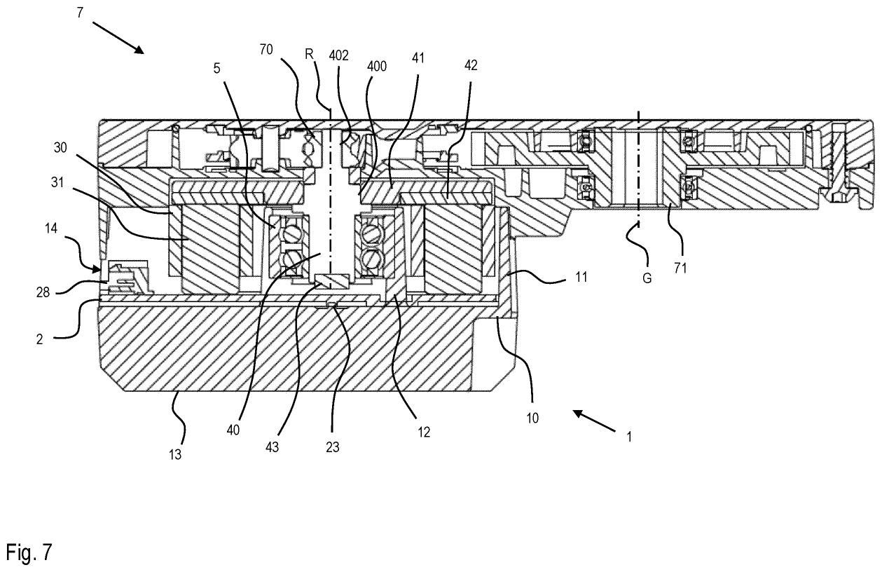

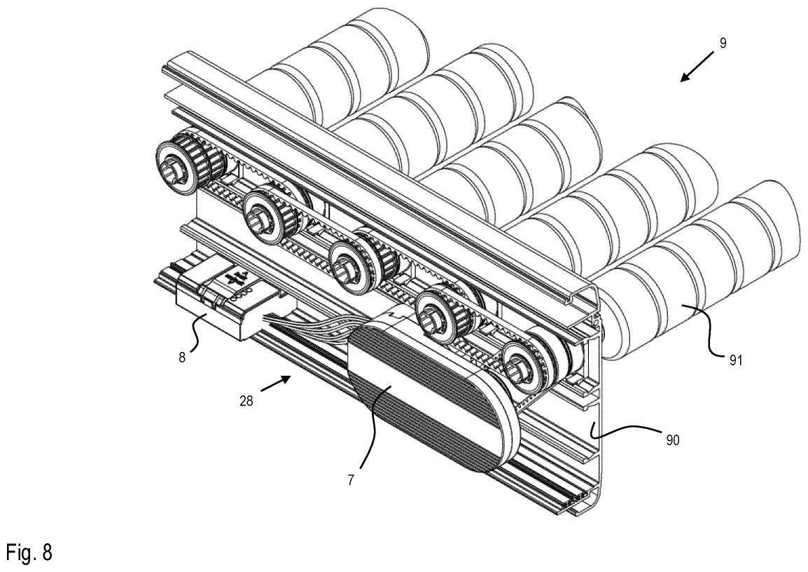

FIG. 7 shows a section view through the rotation axis R of the gear motor of FIG. 6. In this embodiment, the shaft 40 comprises a second bolt 402 that is arranged concentrically on the first bolt 400. A drive gear 70 of the gearbox 7 is fixed to the second bolt 402. The gearbox 7 comprises a driven gear 71 that is operatively connected to the drive gear 70, directly or via some other gears. The rotation axis of the motor is coaxial to the axis of the drive gear and is parallel to the driven gear axis G. A cut-out 14 is formed in one of the side walls 11 of the housing 1, allowing a connector 28 that is arranged on the PCB 2 to be accessed from the outside of the housing 1.

FIG. 8 a perspective view of a conveyor according to the invention. The conveyor comprises the gear motor of FIG. 6 and FIG. 7 that is arranged in a profile 90 on which rollers 91 are rotatably mounted and which rollers are operatively connected to the driven gear of the gear motor. In the depicted embodiment, the rollers comprise lateral pulleys which are connected to the gear motor by means of timing belts. A control unit 8 is arranged next to the gear motor and is connected to it by cables and a plug that is connected to the connector 28 of the axial flux motor of the gear motor. The base plate and the ribs of the housing of the axial flux motor are in contact with the profile 90 whereby heat is transferred from the motor to the profile and from the profile to its environment.

REFERENCE SIGNS LIST

| | |
|---|---|
| 1 | housing |
| 10 | base plate |
| 11 | side wall |
| 12 | reception |
| 120 | slot |
| 121 | shoulder |
| 122 | outer reinforcing rib |
| 123 | inner reinforcing rib |
| 13 | cooling rib |
| 14 | cut-out |
| 2 | PCB |
| 20 | recess |
| 21 | island |
| 22 | connecting bridge |
| 23 | sensor |
| 24 | straight section |
| 25 | outside clearance |
| 26 | inside clearance |
| 27 | soldering pad |
| 28 | connector |
| 3 | stator |
| 30 | coil |
| 31 | core |
| 4 | rotor |
| 40 | shaft |
| 400 | first bolt |
| 401 | socket |
| 402 | second bolt |
| 41 | disc |
| 410 | third bolt |
| 42 | drive magnet |
| 43 | reference magnet |
| 44 | collar |
| 5 | bearing |
| 6 | shaft extension |
| 7 | gearbox |
| 70 | drive gear |
| 71 | driven gear |
| 8 | control unit |
| 9 | conveyor |
| 90 | profile |
| 91 | roller |
| R | rotation axis |
| G | driven gear axis |

1. An axial flux motor comprising a housing (1) with a base plate (10), a PCB (2), a stator (3) with coils (30) and cores (31), and a rotor (4) with a shaft (40), a disc (41) and drive magnets (42), wherein the PCB (2) is arranged between the base plate (10) and the stator (3), and wherein the rotor (4) is arranged in a reception (12) of the housing (1) that has the shape of a sleeve and extends coaxial to the stator (3) from the base plate (10) in between the coils (30),
characterized in that a slot (120) is formed in the reception (12), extending from the base plate (10) to a free end of the reception (12),
in that the PCB (2) comprises a recess (20) through which the reception (12) protrudes, an island (21) which is arranged in a central part of the reception (12), and a connecting bridge (22) that connects the island (21) with the rest of the PCB (2) and that is arranged in the slot (120) of the reception,
and in that a reference magnet (43) is arranged on a first free end of the shaft (40) facing the PCB (2) and in that a sensor (23) is arranged on the island (21) of the PCB (2) facing the shaft (40) and which together form a position sensor for the rotor (4).

2. The axial flux motor according to claim 1, wherein the shaft (40) is arranged in the reception (12) with at least one bearing (5) and wherein the bearing (5) closest to the base plate (10) rests on a shoulder (121) of the reception (12).

3. The axial flux motor according to claim 1, wherein the shaft (40) comprises a collar (44), which rests on the bearing (5) furthest away from the base plate (10) with its side facing the base plate (10) and on which collar (44) rests the disc (41) on the side facing away from the base plate (10).

4. The axial flux motor according to claim 1, wherein on a side of a second free end of the shaft (40) opposite to the first free end, a first bolt (400) is provided, which is arranged in a complementary recess of the disc (41) forming a form-and/or force-fit connection.

5. The axial flux motor according to claim 4, comprising a shaft extension (6) which is arranged in a thereto complementary socket (401) formed in the first bolt (400).

6. The axial flux motor according to claim 4, wherein at the second free end of the shaft (40) a second bolt (402) is provided.

7. The axial flux motor according to claim 1, wherein the reference magnet (43) is arranged in a recess in the front face of the shaft (40).

8. The axial flux motor according to claim 1, wherein a third bolt (410) is provided on a side of the disc (41) facing away from the base plate (10).

9. The axial flux motor according to claim 1, wherein cooling ribs (13) are provided on a side of the base plate (10) opposite the PCB (2).

10. The axial flux motor according to claim 1, wherein lateral side walls (11) extend away from the base plate (10) in the direction of the disc (10).

11. The axial flux motor according to claim 10, wherein a cut-out (14) is formed in one of the side walls (11) of the housing (1) and wherein the PCB (2) comprises a connector (28) which is accessible from the outside through the cut-out (14).

12. A gear motor comprising the axial flux motor according to claim 11 and a gearbox (7) with a drive gear (70) and at least one driven gear (71), wherein the drive gear (70) is fixed to the shaft (40).

13. A conveyor (9) comprising conveying means (91) that are operatively connected to the axial flux motor according to claim 11 or the gear motor according to claim 12.

14. The conveyor (9) according to claim 13, comprising a power and control unit (8) which supplies the axial flux motor according to claim 11.

15. The conveyor (9) according to claim 14, wherein the power and control unit (8) receives control signals from the sensor (23).

16. The conveyor (9) according to claim 12, comprising a power and control unit (8) which supplies the gear motor according to claim 12 with power and control signals.
